(19) United States
(12) Patent Application Publication
(10) Pub. No.: US 2011/0052960 A1
(43) Pub. Date: Mar. 3, 2011

(54) SECONDARY BATTERY MODULE HAVING COOLING CONDUIT

(75) Inventors: Moon-seok KWON, Hwaseong-si (KR); Meen-seon PAIK, Seongnam-si (KR); Ji-sang YU, Yongin-si (KR); Dong-kwan KIM, Hwaseong-si (KR)

(73) Assignee: Samsung Electronics Co., Ltd., Suwon-si (KR)

(21) Appl. No.: 12/722,641

(22) Filed: Mar. 12, 2010

(30) Foreign Application Priority Data
Sep. 3, 2009 (KR) 10-2009-0083151

(51) Int. Cl. H01M 10/50

(52) U.S. Cl. 429/120

(57) ABSTRACT

A secondary battery module including sealed cooling conduits through which a heat transfer medium flows between adjacent unit batteries. The secondary battery module includes a plurality of cooling conduits disposed in parallel facing each other and sealed so that a heat transfer medium flows therein; a plurality of unit batteries disposed between the plurality of cooling conduits; a supply conduit for supplying the heat transfer medium to the plurality of cooling conduits; an exhaust conduit for exhausting the heat transfer medium from the plurality of cooling conduits; and a spacer for maintaining spaces in the cooling conduits by being disposed inside each of the plurality of cooling conduits.

### CROSS-REFERENCE TO RELATED APPLICATIONS

This application claims the benefit of Korean Application No. 10-2009-0083151, filed in the Korean Intellectual Property Office on Sep. 3, 2009, the disclosure of which is incorporated herein by reference.

### BACKGROUND

1. Field

The present disclosure relates to secondary battery modules, and more particularly, to secondary battery modules including a sealed cooling conduit, through which a heat transfer medium flows between adjacent unit batteries.

2. Description of the Related Art

Secondary batteries are widely used as a power supply source to drive various portable electronic devices, such as mobile phones, lap tops, digital cameras, and Moving Picture Experts Group audio layer 3 (MP3) players. Recently, secondary batteries have expanded to being used as a power supply source for moving devices, such as a car. Moreover, demand for secondary batteries in apparatuses for storing renewable energy, such as sunlight power or wind power, as electric power is expected to increase.

A secondary battery used for a car or an apparatus to store electric power is generally required to have higher capacity and higher output than a secondary battery used for a portable electric device. Accordingly, a secondary battery system that has high capacity and high output may be formed by connecting a plurality of unit batteries in series or in parallel. A bundle of a plurality of unit batteries connected in series or in parallel is generally called a secondary battery module, and at least one secondary module may form a secondary battery pack or a secondary battery system.

In secondary battery modules, heat is generated inside each unit battery when unit batteries are charged or discharged. When the generated heat is not properly dissipated out of the unit batteries, performance of the unit batteries may deteriorate. Also, when there are temperature variations in a unit battery, the performance deterioration of the unit battery may become worse as the temperature variations increase. Accordingly, the heat generated in each unit battery in the secondary battery module should be appropriately dissipated out of the unit batteries. Consequently, various cooling structures of a secondary battery module to dissipate heat generated in the unit batteries out of the unit batteries are suggested. Such cooling structures should not cause any mechanical, thermal, or chemical problems to the unit batteries and the secondary battery module, even when the volume of the unit batteries changes.

### SUMMARY

Provided are secondary battery modules including a sealed cooling conduit, through which a heat transfer medium flows between adjacent unit batteries.

According to an aspect of the present invention, a secondary battery module is provided. The secondary battery module includes: a plurality of cooling conduits disposed in parallel facing each other and sealed so that a heat transfer medium flows therein; a plurality of unit batteries disposed between the plurality of cooling conduits; a supply conduit to supply the heat transfer medium to the plurality of cooling conduits; an exhaust conduit to exhaust the heat transfer medium from the plurality of cooling conduits; and a spacer disposed inside each of the plurality of cooling conduits to maintain a space in each of the cooling conduits.

According to another aspect of the present invention, the spacer may serve as a compression spring having elasticity in a direction that in which cooling conduits are compressed by the unit batteries on each side of each of the cooling conduits.

According to another aspect of the present invention, the spacers may have a shape of a bent board, a shape of a board having an uneven surface or having protrusions, a shape of a board partially cut or having a hole, a mesh shape, a wire shape, a sphere shape, a tube shape, or a combination of shapes thereof.

According to another aspect of the present invention, the spacers may be formed separately from the cooling conduits and inserted into the cooling conduits.

According to another aspect of the present invention, the spacers may be formed with the cooling conduits as a single body.

According to another aspect of the present invention, a shape, an arrangement configuration, or an arrangement frequency of the spacers may differ according to a location of the spacers within the cooling conduits.

According to another aspect of the present invention, an occupation density or occupation surface area of the spacers may increase downstream of a moving path of the heat transfer medium in the cooling conduits.

According to another aspect of the present invention, an occupation density of the spacers at the edge of a moving path of the heat transfer medium in the cooling conduits may be higher than an occupation density of the spacers at the center of the moving path.

According to another aspect of the present invention, the cooling conduits may be divided into a plurality of sections according to location, and spacers disposed in one of the plurality of sections have a shape different from spacers disposed in each of the other sections.

According to another aspect of the present invention, the plurality of cooling conduits and the plurality of unit batteries may have flat board shapes having wide and flat surfaces in width and height directions, and narrow and long surfaces in a thickness direction.

According to another aspect of the present invention, the wide and flat surfaces of the cooling conduits and the unit batteries may contact each other.

According to another aspect of the present invention, insulation films may be disposed between each of the plurality of cooling conduits and the unit batteries.

According to another aspect of the present invention, a thickness of each of the plurality of cooling conduits a range from about 0.1 mm to about 20 mm.

According to another aspect of the present invention, the supply conduit and the exhaust conduit may be disposed on sides of the cooling conduits, and a plurality of parallel grooves may be formed on inner walls of the supply conduit and the exhaust conduit.

According to another aspect of the present invention, the plurality of cooling conduits are inserted into the plurality of grooves formed on the inner walls of the supply conduit and the exhaust conduit so as to connect the plurality of cooling conduits to the supply conduit and the exhaust conduit.

According to another aspect of the present invention, the cooling conduits may be connected to the supply conduit and the exhaust conduit via a brazing method.

According to another aspect of the present invention, the supply conduit and the exhaust conduit may have a pipe shape, the supply conduit may be disposed on one edge of the cooling conduit, and the exhaust conduit may be disposed on another edge of the cooling conduits, and a plurality of first subsidiary conduits connected to the supply conduit may be connected to one corner of the cooling conduits, and a plurality of second subsidiary conduits connected to the exhaust conduit may be connected to another corner of the cooling conduits, so as to supply and exhaust the heat transfer medium.

According to another aspect of the present invention, the secondary battery module may further include a separate heat exchanger connected to the supply conduit and the exhaust conduit.

According to another aspect of the present invention, the spacers may have a parallel lattice pattern. A width of the spacers may be larger than a width of the cooling conduits.

According to another aspect of the present invention, the secondary battery module may further include: two end plates respectively disposed on each end of the secondary battery module; and a restraining unit fixed between the two end plates to provide resistance in a direction such that a distance between the two end plates increases.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view illustrating a schematic structure of a secondary battery module including a cooling conduit, according to an embodiment of the present invention;

FIGS. 2A through 2C are perspective views schematically illustrating a structure and an arrangement of the cooling conduit and a unit battery of the secondary battery module illustrated in FIG. 1;

FIG. 2D is a diagram illustrating an example of a structure where an insulation film is disposed between a cooling conduit and a unit battery;

FIG. 3 is a perspective view illustrating a secondary battery module including a cooling conduit, according to another embodiment of the present invention;

FIG. 4 is a cross-sectional view schematically illustrating a cooling conduit and a spacer disposed inside the cooling conduit;

FIGS. 5A through 5F are cross-sectional views schematically illustrating various examples of a cooling conduit and a spacer disposed inside the cooling conduit;

FIGS. 6A through 6L are cross-sectional views illustrating various shapes of a spacer that may be disposed in a cooling conduit;

FIGS. 7A through 7D are plan views illustrating various shapes of a spacer;

FIGS. 8A through 8E are cross-sectional views illustrating various shapes of a spacer integrated into a cooling conduit;

FIGS. 9A and 9B are diagrams illustrating shape change of a cooling conduit according to volume change of a unit battery during charging and discharging;

FIGS. 10A through 10C are plan views illustrating arrangements of a spacer;

FIGS. 11A and 11B are perspective views showing how a spacer having various shapes is inserted into a cooling conduit;

FIG. 12 is a plan view illustrating a structure of a spacer;

FIGS. 13A and 13B are diagrams of a combination relationship between the spacer of FIG. 12 and a cooling conduit; and

FIGS. 14A through 14C are plan views illustrating various modified examples of the spacer of FIG. 12.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

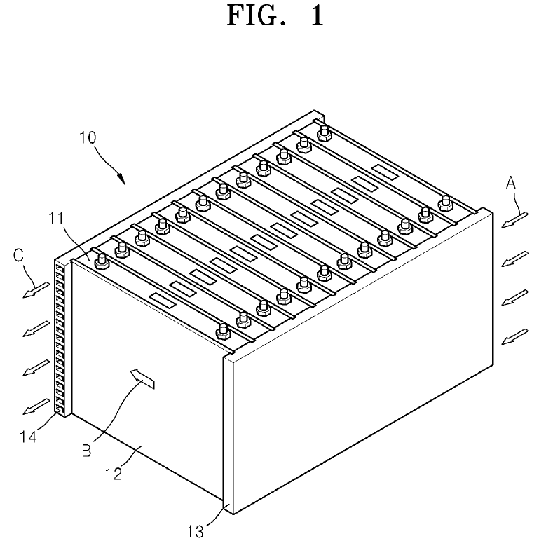

FIG. 1 is a perspective view illustrating a schematic structure of a secondary battery module 10 including a cooling conduit 12, according to an embodiment of the present invention. The secondary battery module 10 may include a plurality of the cooling conduits 12 disposed in parallel and facing each other, a unit battery 11 disposed between the plurality of cooling conduits 12, a supply conduit 13, and an exhaust conduit 14. The supply conduit 13 supplies a heat transfer medium into the plurality of cooling conduits 12. The exhaust conduit 14 exhausts the heat transfer medium from the plurality of cooling conduit 12. The cooling conduits 12 are disposed in the spaces between the unit batteries 11 and on outer sides of the unit batteries 11 at each end of the secondary battery module 10.

Although not illustrated in FIG. 1, an end plate having a flat board shape and may be disposed on each end of the secondary battery module 10 parallel to the unit battery 11 and the cooling conduits 12. In order to prevent a change in the overall length of the secondary battery module 10 due to an increase of volume of the unit battery 11 while charging the unit battery 11, a restraining unit (not shown) may be disposed between the two end plates. Since the restraining unit is fixed between the two end plates, resistance may be provided in a direction such that a space between the end plates increases.

The unit battery 11 is a secondary battery that can be repeatedly charged and discharged, and may be square shaped or pouch shaped. As shown in FIG. 1, each of a plurality of the unit batteries 11 may have wide and flat surfaces in width and height directions and narrow and long surfaces in a thickness direction so as to be easily inserted into and disposed in the secondary battery module 10. The plurality of unit batteries 11 may be arranged in such a way that the wide and flat surfaces are parallel and face each other. A plurality of predetermined spaces may be provided between the plurality of unit batteries 11 for the cooling conduits 12.

As shown in FIG. 1, like the unit batteries 11, the cooling conduits 12 may also have wide and flat surfaces in width and height directions and narrow and long surfaces in a thickness direction. In this case, the unit batteries 11 may be effectively cooled since areas of contact between the wide and flat surfaces of the cooling conduits 12 and the wide and flat surfaces of the unit batteries 11 are maximized. However, portions of surfaces of the cooling conduits 12 that do not contact the wide and flat surfaces of the unit batteries 11 may be shaped differently, and are not limited to the shown arrangements.

In FIG. 1, the cooling conduits 12 disposed between the plurality of unit batteries 11 are each connected to the supply conduit 13 and the exhaust conduit 14 and are parallel to each other. When the heat transfer medium flows in a direction A through the supply conduit 13, the heat transfer medium is supplied to each cooling conduit 12 from the supply conduit 13. After the heat transfer medium flows in a direction B within the cooling conduits 12, the heat transfer medium is then exhausted in a direction C through the exhaust conduit 14 from each cooling conduit 12.

Alternatively, although not illustrated, the plurality of cooling conduits 12 may be connected in series. In this case, the supply conduit 13 and the exhaust conduit 14 may be disposed at the cooling conduits 12 at each end of the secondary battery module 10. The heat transfer medium is supplied to the cooling conduit 12 at one end of the secondary battery module 10 from the supply conduit 13 and then successively flows from the cooling conduit 12 at one end, through the intermediate cooling conduits 12, and then to the cooling conduit 12 at another end of the secondary battery module 10. The heat transfer medium is then exhausted from the cooling conduit 12 at the other end of the secondary battery module 10 to the exhaust conduit 14. When the cooling conduits 12 are connected in series, the cooling conduits 12 may be configured to have zigzag shapes via a bending process, or the like. Alternatively, other conduits having another shape may be connected in parallel to sides of the cooling conduits 12.

The cooling conduits 12 are sealed from external air such that the heat transfer medium only flows through the cooling conduits 12. The entire conduit system including the supply conduit 13 and the exhaust conduit 14 respectively supplying and exhausting the heat transfer medium to and from the cooling conduits 12 in the secondary battery module 10 may be sealed from external air.

The entire thickness of each of the cooling conduits 12 may, for example, range from about 0.1 mm to about 20 mm. When the entire thickness of the cooling conduits 12 is above 20 mm, the volume that may be occupied by the unit batteries 11 in the secondary battery module 10 decreases, and thus the energy density of the secondary battery module 10 may decrease. On the other hand, when the entire thickness of the cooling conduits 12 is below 0.1 mm, the amount of the heat transfer medium that flows through the cooling conduits 12 may not be sufficient, since the resistance of line inside the cooling conduits 12 increases. In this case, the thickness of an external wall of the cooling conduits 12 may be decreased, but then mechanical stability of the cooling conduits 12 may deteriorate.

The cooling conduits 12 contact the unit batteries 11, and thus there may be a thermal conduction path where the heat generated in the unit batteries 11 is transferred to the heat transfer medium inside the cooling conduits 12. Accordingly, the cooling conduits 12 may be formed of a material having high thermal conductivity. When the cooling conduits 12 deform elastically due to the volume change of the unit batteries 11, changes in the thermal conductivity may be reduced if the cooling conduits 12 are maintained in contact with the unit batteries 11. Accordingly, the cooling conduits 12 may be formed of a material that can repeatedly elastically deform.

Metal is one example of a material that can satisfy the above conditions. For example, stainless steel, copper, aluminum, or silver, may be used to form the cooling conduits 12. When a metal is used to form the cooling conduits 12, the internal heat transfer medium may be easily sealed in the cooling conduits 12, and the cooling conduits 12 may be easily processed using a metal board, or the like. The thickness of the metal material may be, for example, about 10 μm or greater. However, a non-metal may be used to form the cooling conduits 12, as long as the non-metal has heat resistance and high thermal conductivity, and can be repeatedly deformed elastically.

As described above, the heat transfer medium flows inside the cooling conduits 12 in order to dissipate the heat generated in the unit batteries 11. Since the cooling conduits 12 are sealed, the heat transfer medium only flows inside the cooling conduits 12, does not contact external air, and does not leak out of the cooling conduits 12. For sufficient heat dissipation, the heat transfer medium may have an average volumetric heat capacity value of 0.1 MJ/(m³·K) or greater. For example, the average volumetric heat capacity value may be 1 MJ/(m³·K) or greater. Examples of the heat transfer medium include liquid water, methanol, ethanol, propanol, butanol, silicon oil, ammonia, acetone, and mixtures thereof, but the heat transfer medium is not limited thereto. Such examples of the heat transfer medium are in a fluid state in environments in which heat dissipating is normally performed. Alternatively, the heat transfer medium may be a mixture in which various types of materials are mixed, a heterogeneous mixture in which various phases of materials are mixed, a suspension, or a colloid.

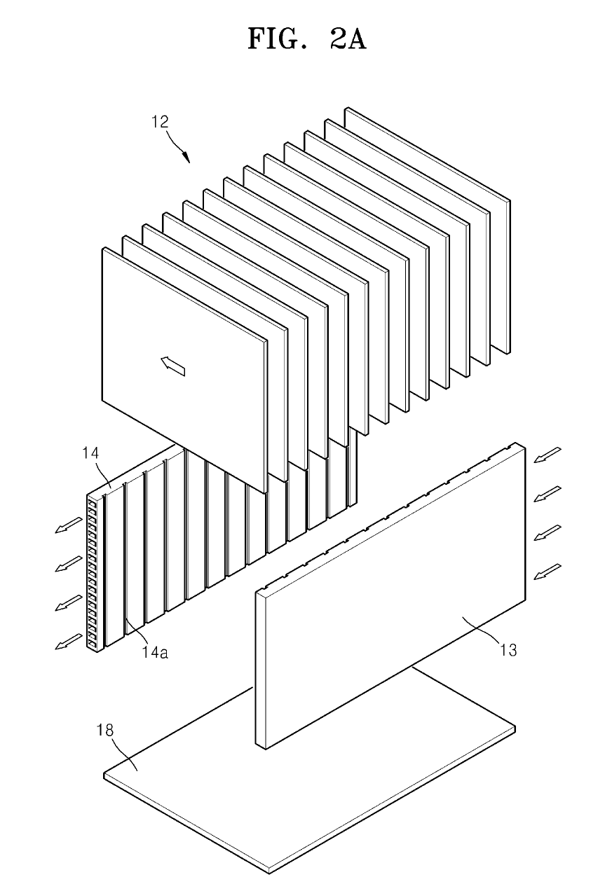

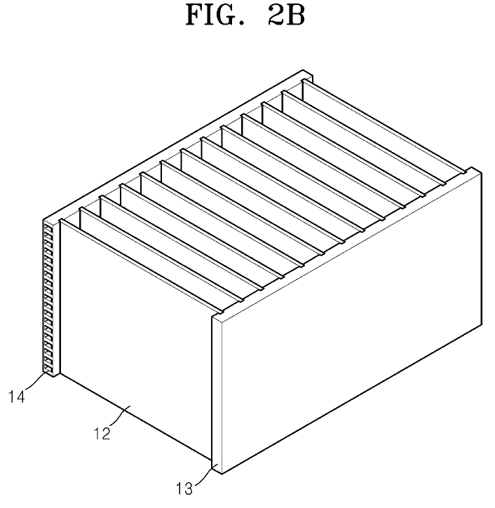

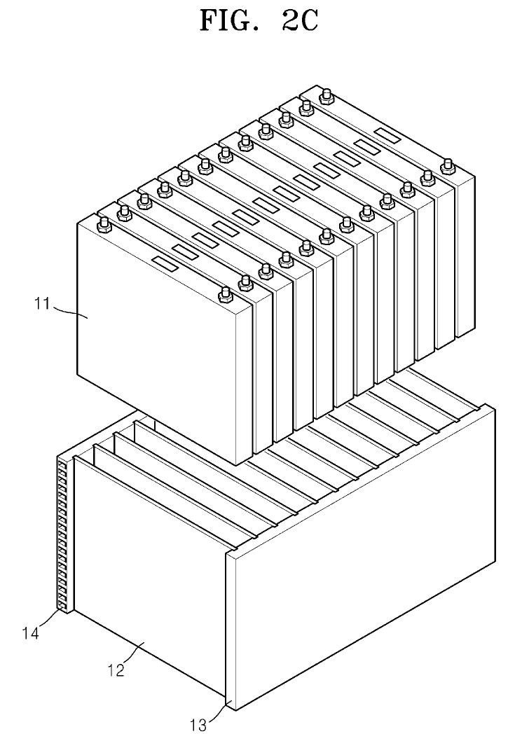

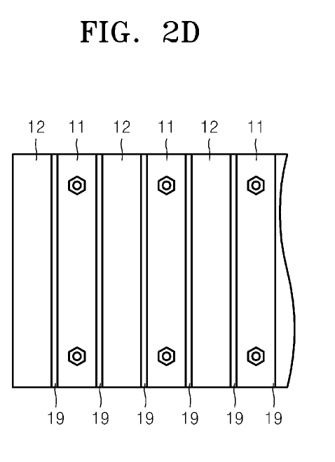

FIGS. 2A through 2C are perspective views schematically illustrating a structure and an arrangement of the cooling conduits 12 and the unit batteries 11 of the secondary battery module 10 illustrated in FIG. 1. Referring to FIG. 2A, the entire conduit system, including the cooling conduits 12, the supply conduit 13, and the exhaust conduit 14, is illustrated. All of the cooling conduits 12, the supply conduit 13, and the exhaust conduit 14 have a board shape having flat and wide surfaces, and may be fixed to a bottom board 18. A plurality of parallel grooves 14a are formed on an inner wall of the exhaust conduit 14, and the cooling conduits 12 may be fixed to the exhaust conduit 14 by being inserted into the grooves 14a, perpendicularly. The heat transfer medium in the cooling conduits 12 may flow to the exhaust conduit 14 through the grooves 14a. Although not illustrated, grooves identical to the grooves 14a of the exhaust conduit 14 may be formed on an inner wall of the supply conduit 13. Accordingly, the heat transfer medium may flow along a direction indicated by arrows, from the supply conduit 13 to the exhaust conduit 14 through the cooling conduits 12.

As illustrated in FIG. 2A, the cooling conduits 12 may have an empty rectangular box shape so that the heat transfer medium may flow inside the cooling conduits 12. Specifically, the cooling conduits 12 may have a flat board shape having wide and flat surfaces in width and height directions and narrow and long surfaces in a thickness direction. Accordingly, the cooling conduits 12 may be formed by processing a metal board. For example, the cooling conduits 12 may be formed by bending a board such that corners of the board are adjacent to each other, or by combining edges of two boards facing each other.

The cooling conduits 12 prepared as described above may be fixed and connected after being inserted into the supply conduit 13 and the exhaust conduit 14, as shown in FIG. 2B. When all of the cooling conduits 12, the supply conduit 13, and the exhaust conduit 14 are formed of a metal, they may be connected to each other using a well known brazing method. According to the brazing method, two metal portions are connected to each other by applying heat in a temperature lower than solid temperature using a filler metal having a liquid temperature of 450 degrees Celsius or above. Accordingly, the cooling conduits 12, the supply conduit 13, and the exhaust conduit 14 may be completely sealed. The plurality of unit batteries 11 may then be inserted between the cooling conduits 12 as shown in FIG. 2C, so as to complete the secondary battery module 10.

Though the wide and flat surfaces of the cooling conduits 12 and the wide and flat surfaces of the unit batteries 11 may contact each other directly, insulation films 19 (shown in FIG. 2D) may be disposed between the cooling conduits 12 and the unit batteries 11 in order to prevent current leakage from the unit batteries 11 to the cooling conduits 12. FIG. 2D illustrates an example of a structure where the insulation films 19 are disposed between the cooling conduits 12 and the unit batteries 11. The insulation films 19 may not only function as an insulator but may also improve thermal conductivity. Thus, the insulation films 19 may be an oxide layer or a polymer layer. For example, the insulation films 19 may be formed of thermal grease, although the composition of the insulation films 19 is not limited thereto. In order to prevent the thermal conductivity from decreasing, the thickness of each of the insulation films 19 may be about 1 mm or less.

According to the secondary battery module 10 described above, since the area of contact of the unit batteries 11 and the heat transfer medium is large, the heat generated in all of the unit batteries 11 included in the second battery module 10 may be effectively dissipated out of the unit batteries 11. In addition, since the cooling conduits 12 having the flat board shape restrain the unit batteries 11, the cooling conduits 12 may accommodate the unit batteries 11.

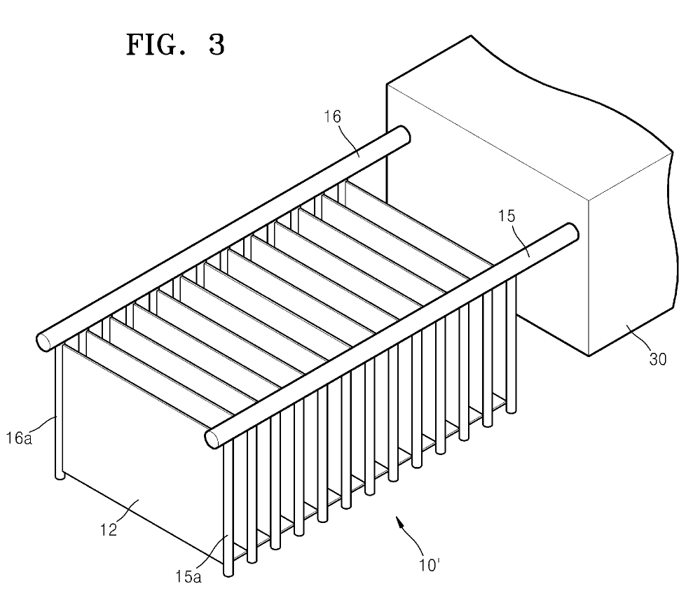

FIG. 3 is a perspective view illustrating a secondary battery module 10′ including the cooling conduits 12, according to another embodiment of the present invention. For convenience, the unit batteries 11 are not illustrated in FIG. 3. Referring to FIG. 3, unlike FIG. 1, a supply conduit 15 and an exhaust conduit 16 have a pipe shape instead of a flat board shape. However, the cooling conduits 12 have a flat board shape, such as in FIG. 1. As shown in FIG. 3, the supply conduit 15 and the exhaust conduit 16 are each disposed on two upper edges of the cooling conduits 12, respectively. In other words, the supply conduit 15 is disposed on one edge of the cooling conduits 12, and the exhaust conduit 16 is disposed on another edge of the cooling conduits 12.

However, the locations of the supply conduit 15 and the exhaust conduit 16 are not limited to the upper edges of the cooling conduits 12. For example, the supply conduit 15 and the exhaust conduit 16 may each be disposed on two bottom edges of the cooling conduits 12, respectively, or on both of top and bottom edges of the cooling conduits 12, respectively. Alternatively, the supply conduit 15 and the exhaust conduit 16 may be disposed diagonally to the cooling conduits 12, with one on the top edge and the other on the bottom edge. A plurality of first subsidiary conduits 15a connected to the supply conduit 15 may be connected to one corner of the cooling conduits 12, and a plurality of second subsidiary conduits 16a connected to the exhaust conduit 16 may be connected to another corner of the cooling conduits 12, in order to supply and exhaust the heat transfer medium.

A heat exchanger 30 may be separately connected to the supply conduit 15 and the exhaust conduit 16 in order to increase cooling efficiency. In this case, the heat transfer medium that absorbed heat from the unit batteries 11 while flowing through the cooling conduits 12 dissipates the absorbed heat to the heat exchanger 30, and then is supplied back to the cooling conduits 12. Although not illustrated in FIG. 1, the heat exchanger 30 may also be included in the secondary battery module 10 of FIG. 1.

As described above, the unit batteries 11 may repeatedly expand and contract while the unit batteries 11 are being repeatedly charged and discharged. Even when the unit batteries 11 expand or contract, the surfaces of the cooling conduits 12 may maintain contact with the surfaces of the unit batteries 11 without detaching therefrom. Accordingly, the cooling conduits 12 having the flat board shape have elasticity and hardness. However, since the cooling conduits 12 are thin, mechanical reliability of the cooling conduits 12 may be low. Consequently, a reinforcing material may be further added in order to maintain spaces in the cooling conduits 12.

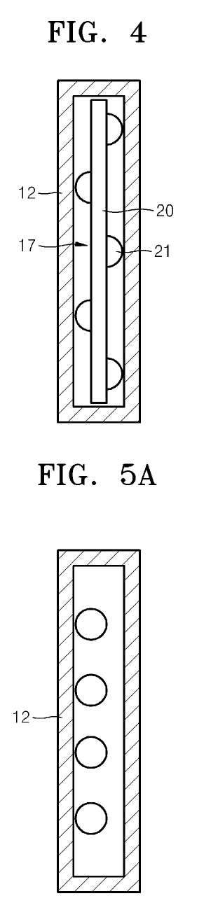

FIG. 4 is a cross-sectional view schematically illustrating one of the cooling conduits 12 and a spacer 17 disposed inside the shown cooling conduit 12. As shown in FIG. 4, the spacer 17 may have a structure where a plurality of protrusions 21 is formed on a thin board 20. The spacer 17 may maintain the space in the cooling conduit 12 from shrinking below a predetermined degree. Accordingly, a uniform space in the cooling conduit 12 is obtained so that the heat transfer medium may flow through the cooling conduit 12. The spacer 17 may function as a compression spring so as to provide elastic stability to walls of the cooling conduit 12. The spacer 17 may be formed of any material and may have any shape, so long as the spacer 17 is able to perform the functions described above. For example, a metal having excellent thermal conductivity, such as stainless steel, aluminum, or copper, may be used to form the spacer 17, in order to quickly transfer heat from inner walls of the cooling conduit 12 to the heat transfer medium. However, other non-metallic materials having excellent thermal conductivity may also be employed. FIG. 4 illustrates the spacer 17 contacting two inner walls of the cooling conduit 12, but the spacer 17 may instead contact only one inner wall, or may not contact any inner wall at all.

In FIG. 4, the spacer 17 having the protrusions 21 formed on the thin board 20 is illustrated, but the spacer 17 may have any one of various shapes. For example, the spacer 17 may have a spherical shape or a shape similar to a sphere, such as a hemisphere or an oval. Alternatively, the spacer 17 may have a mesh shape, a wire shape or a shape similar to a wire, a plurality of tubes shape or a shape where a plurality of tubes are combined, a shape where at least a portion of a board is bent, a shape where a board has an uneven surface or has protrusions, a shape where at least a portion of a board is processed, for example, a portion is cut or a hole is formed, a shape where another material is adhered to a part of a board, or a shape formed of a combination of shapes thereof. The above shapes should be seen as merely examples, and the spacer 17 may have any shape including shapes not expressly discussed above.

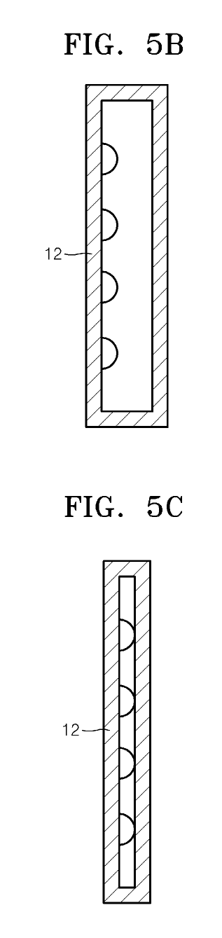

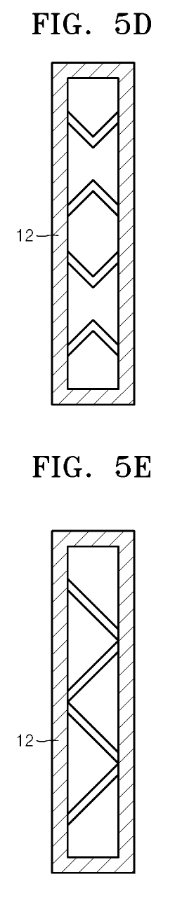

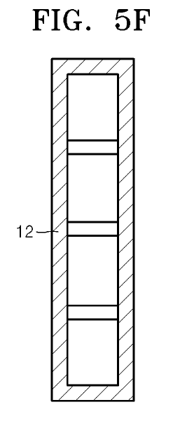

Thus, the spacer 17 may be formed to have one of several shapes through various methods. FIGS. 5A through 5F are cross-sectional views schematically illustrating various examples of the cooling conduits 12 and spacers disposed inside the cooling conduits 12. As shown in FIGS. 5A through 5C, the spacers may have a spherical or hemispherical shape, and may be formed on one inner wall of the cooling conduits 12. Alternatively, as shown in FIGS. 5D through 5F, the spacers may have a shape where a plurality of boards contact both inner walls of the cooling conduits 12 at various angles.

The spacer 17 may be elastically stressed in a thickness direction of the cooling conduits 12, i.e., in a direction in which the cooling conduits 12 are compressed by the unit batteries 11 on both sides of the cooling conduits 12. Accordingly, the spacer 17 may be formed of a material having a wide intrinsic elastic deformation range, such as metal or rubber. The spacer 17 may have a spring shape, an uneven shape, a curved shape, a folded shape, a bent shape, a hollow shape, a curved surface or curved line shape, or a shape formed of a combination of shapes thereof, in order to have high elasticity.

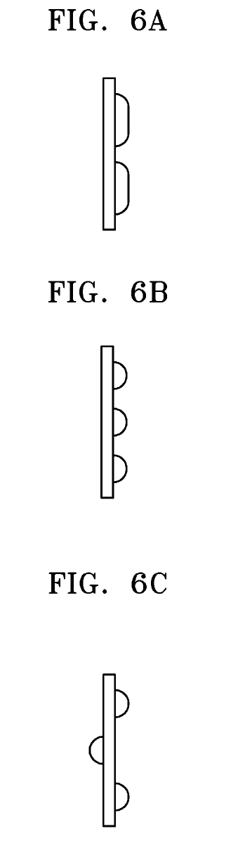

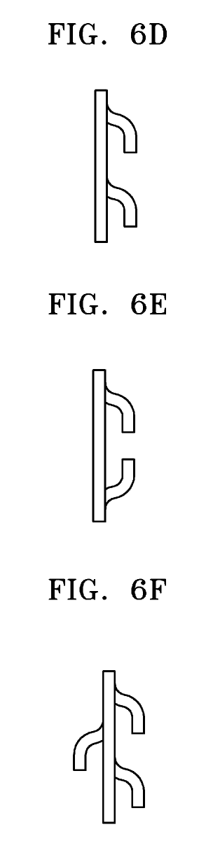

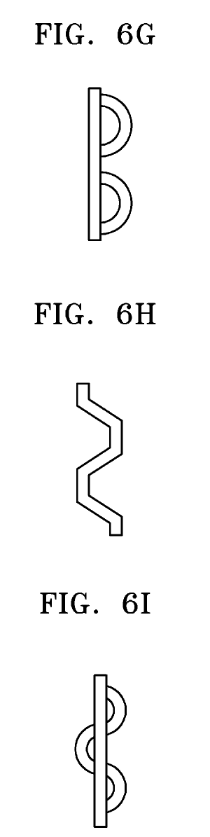

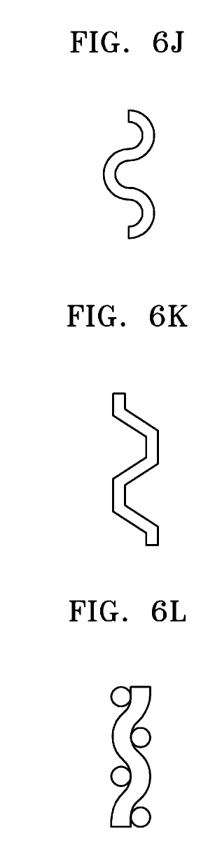

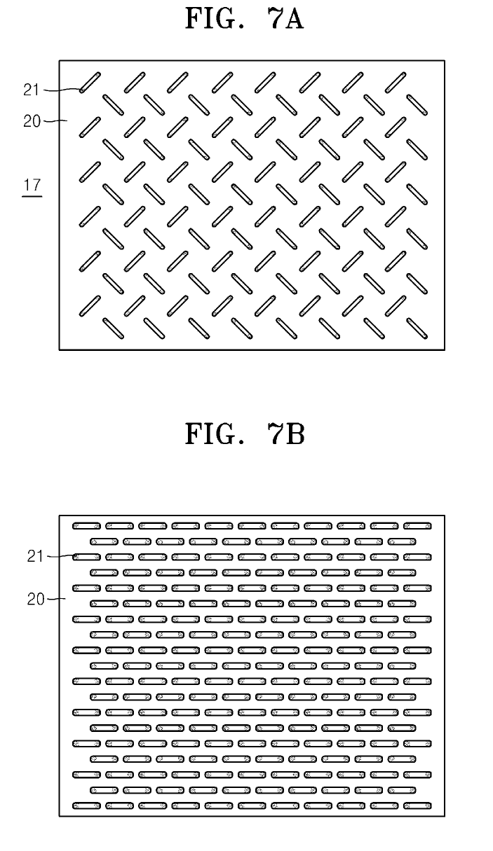

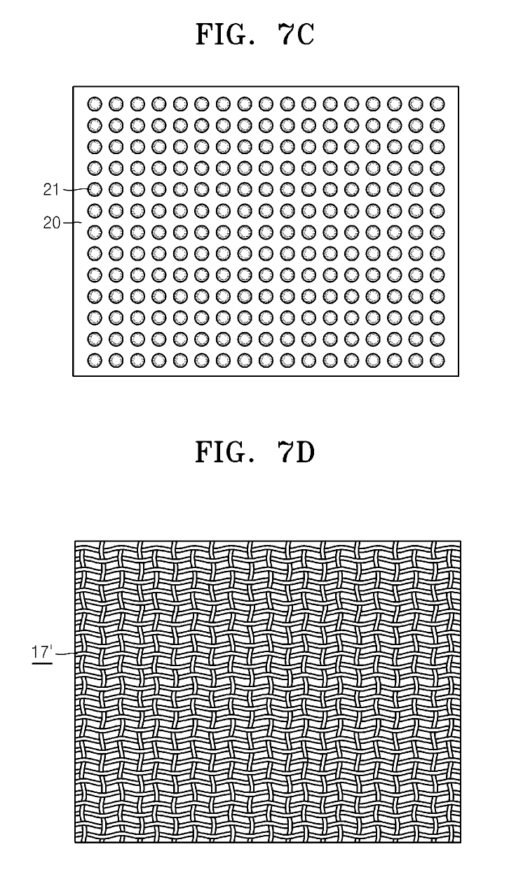

FIGS. 6A through 6L are cross-sectional views illustrating various shapes of a spacer, and FIGS. 7A through 7D are plan views illustrating various shapes of a spacer. As shown in FIGS. 6A through 6L, spacers that may be elastically stressed may be prepared by adhering protrusions of various shapes to a thin board, or by bending a thin board into various shapes. Also, as shown in FIGS. 7A through 7C, the spacers 17 may be prepared in such a way that the protrusions 21 formed on the thin board 20 are uniformly arranged in a 2 dimension (2D) arrangement in various directions. Alternatively, as shown in FIG. 7D, a spacer 17′ having a mesh shape may be prepared.

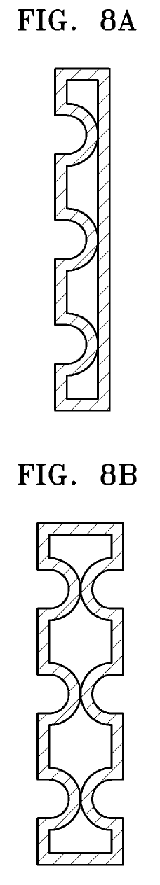

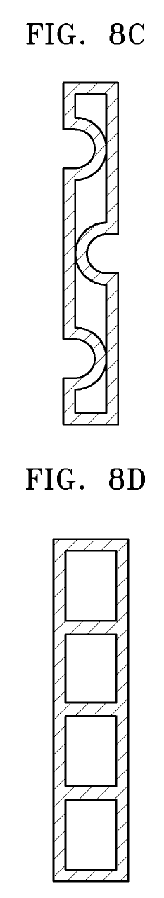

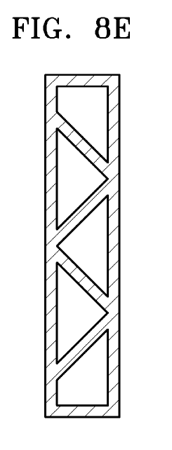

The spacer 17 may be prepared separately from the cooling conduits 12 and then inserted into one of the cooling conduits 12. Alternatively, the spacer 17 and one of the cooling conduits 12 may be prepared as a single body using the same material. FIGS. 8A through 8E are cross-sectional views illustrating various shapes of the spacer 17 integrated into one of the cooling conduits 12.

When the spacer 17 is elastically stressed in one of the cooling conduits 12, the spacer 17 may push the walls of the cooling conduits 12 when the unit batteries 11 are installed inside the second battery module 10. Accordingly, the surfaces of the cooling conduits 12 maintain contact with the surfaces of the unit batteries 11. In this case, heat conduction occurs uniformly and smoothly between the surfaces of the unit batteries 11 and the cooling conduits 12.

The volume of the unit batteries 11 may change as the unit batteries 11 expand and contract when charging and discharging. Spaces between the unit batteries 11 may change, and a degree of the change may differ according to location. The spacer 17 may deform elastically according to the change of spaces between the unit batteries 11 as the unit batteries 11 are charged or discharged. Thus, the spacer 17 continuously compresses the walls of one of the cooling conduits 12, so that the surfaces of the cooling conduits 12 and the unit batteries 11 uniformly contact each other.

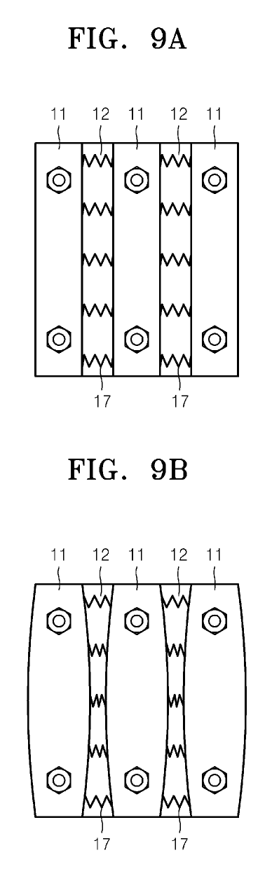

FIGS. 9A and 9B are diagrams illustrating a shape change of the cooling conduits 12 according to a volume change of the unit batteries 11 during charging and discharging. In FIGS. 9A and 9B, the spacer 17 is simply illustrated as compression springs. Using the spacer 17, the surfaces of one of the cooling conduits 12 and the unit batteries 11 uniformly contact each other even when the unit batteries 11 contract by being discharged as shown in FIG. 9A, or expand by being charged as shown in FIG. 9B.

The spacer 17 may have a uniform surface, or a surface state of the spacer 17 may change according to location. Generally, when heat is transferred by convection, more heat is transferred when the heat transfer medium has a higher flow rate, a turbulent flow, or a wider heat transferring area. Since the spacer 17 is located inside the cooling conduits 12, the spacer 17 affects the flow of the heat transfer medium. Specifically, the overall shape and surface state of the spacer 17 may affect the flow rate and formation of turbulent flow of the heat transfer medium, and may change areas of surfaces where convection heat transmission occurs. Accordingly, the degree of the convection heat transmission between the surfaces of the cooling conduits 12 and the heat transfer medium, or between the spacer 17 and the heat transfer medium may change according to the overall shape and the surface state of the spacer 17. Accordingly, it is possible to adjust flux density of heat transferred to the cooling conduits 12 at a predetermined location of the unit batteries 11.

Another configuration example of the spacer 17 in view of details discussed above will now be described. Generally, when the heat transfer medium moves through the cooling conduits 12, the temperature of the heat transfer medium increases as the heat transfer medium absorbs heat generated in the unit batteries 11. Accordingly, a temperature difference between the surfaces of the cooling conduits 12 and the heat transfer medium decreases downstream of the moving path of the heat transfer medium, and thus the amount of heat transferred through the convection downstream also decreases. In order to prevent such a phenomenon, the flow rate may be higher downstream of the moving path than upstream of the moving path, higher turbulent flow may be formed, or the area of heat transmission may be increased. Such conditions may be achieved by changing the shape of the spacer 17 formed inside the cooling conduits 12. In addition, if a temperature of one location is higher than a temperature of another location in the secondary battery module 10, the spacer 17 near the warmer location may be adjusted so as to increase heat flux density of the warmer location.

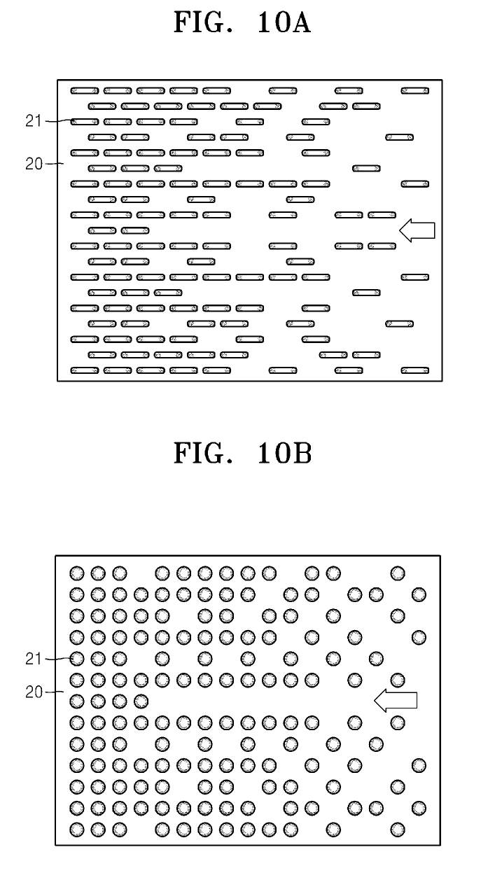

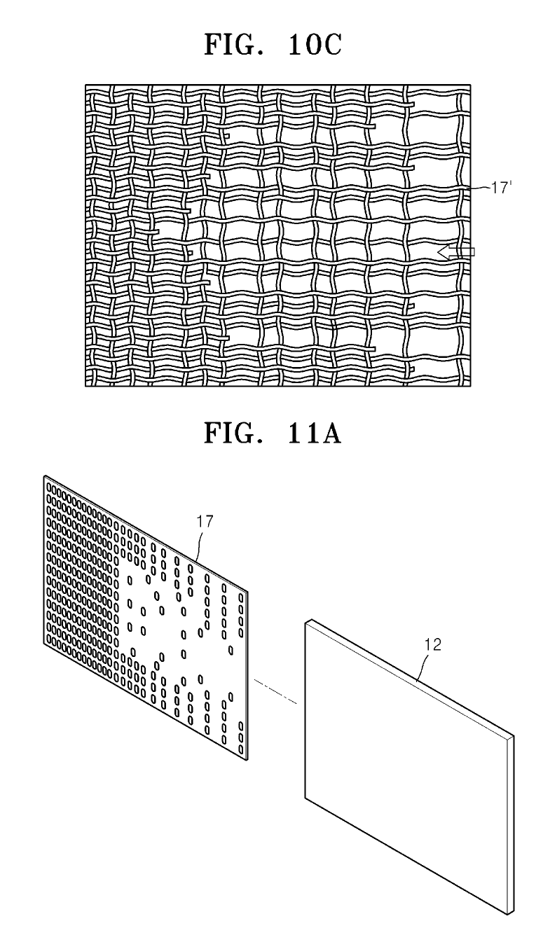

FIGS. 10A through 10C are plan views illustrating example arrangements of spacers. FIG. 10A illustrates the spacer 17 having a shape where a plurality of parallel linear protrusions 21 are formed on the thin board 20. FIG. 10B illustrates the spacer 17 having a shape where a plurality of spherical protrusions 21 are formed on the thin board 20. FIG. 10C illustrates the spacer 17′ having a mesh shape.

Referring to the surfaces of the spacers 17 and 17′ illustrated in FIGS. 10A through 10C, occupation density or occupation surface area of the protrusions 21 or the mesh increases in the moving direction of the heat transfer medium indicated in an arrow. The occupation density of the spacers 17 and 17′ is higher at the top and bottom edges than at the center. According to such surfaces, the heat transfer medium has a lower flow rate and less turbulent flow upstream, whereas the heat transfer medium has a higher flow rate and more turbulent flow downstream. Similarly, the heat transfer medium has higher flow rate and more turbulent flow at the upper and bottom edges than at the center. Accordingly, excellent convection heat transmission by the heat transfer medium is maintained downstream. By changing the shape, the arrangement configuration, and the arrangement frequency of the spacer 17 according to locations in the cooling conduits 12, the heat flux density may be adjusted according to the location. Consequently, temperatures in the secondary battery module 10 may be substantially uniformly maintained in all locations, without using a separate complex control device.

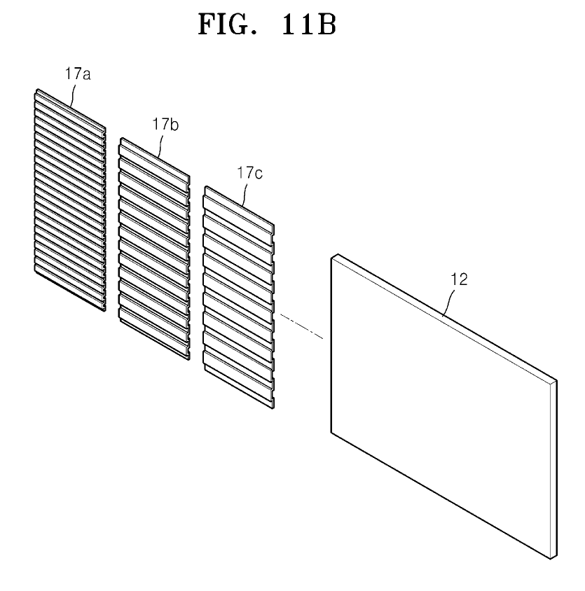

FIGS. 11A and 11B are perspective views describing how the spacer 17 having various shapes is inserted into one of the cooling conduits 12. FIGS. 11A and 11B are diagrams showing how the spacer 17 having the shape illustrated in FIG. 10B may be inserted into one of the cooling conduits 12. In FIG. 11A, one spacer 17 having different surfaces according to location is inserted into the cooling conduits 12. However, a plurality of spacers 17 having different surfaces may also be inserted into the cooling conduits 12. Referring to FIG. 11B, a plurality of spacers 17a, 17b, and 17c formed by bending boards several times are inserted into the cooling conduits 12. The boards of each of the spacers 17a, 17b, and 17c, may have different bending frequencies. As shown in FIG. 11B, the spacer 17c having the lowest bending frequency may be disposed upstream of the moving direction of the heat transfer medium, and the spacer 17a having the highest bending frequency may be disposed downstream of the moving direction. In this manner, the cooling conduits 12 may be divided into a plurality of sections according to location, and spacers having different shapes may be disposed in each section.

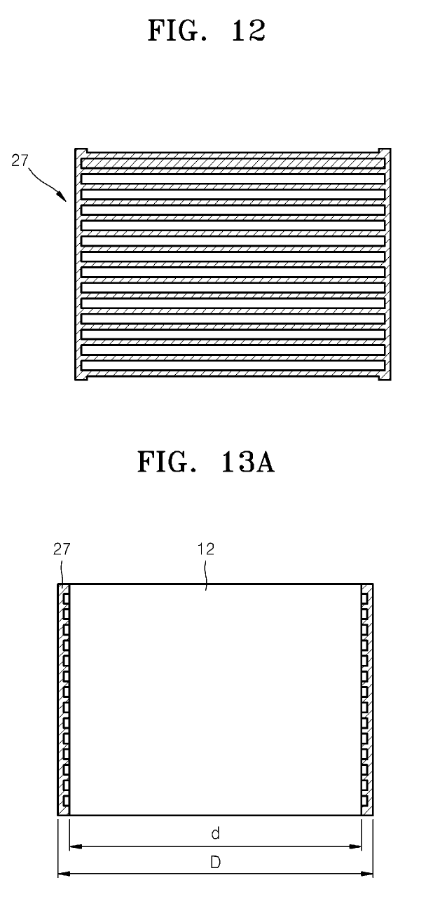

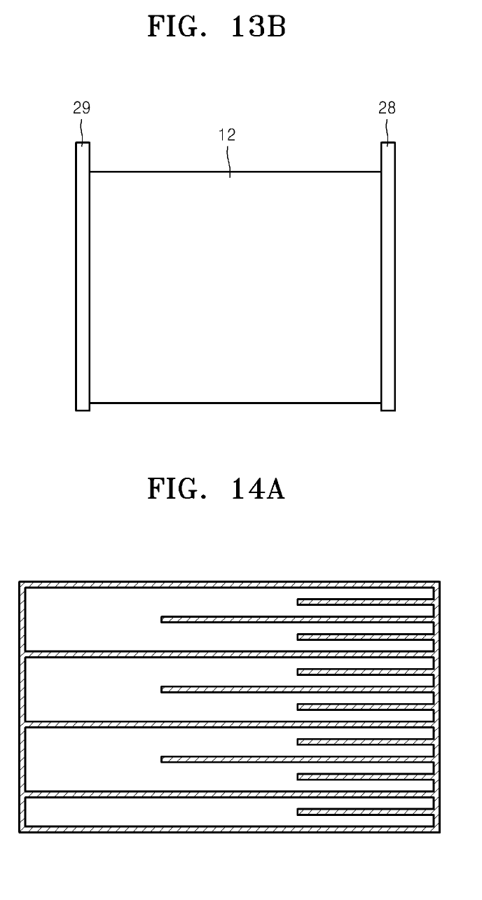

FIG. 12 is a plan view illustrating a structure of a spacer 27. FIGS. 13A and 13B illustrate a combination relationship between the spacer 27 of FIG. 12 and the cooling conduits 12. The spacer 27 has a shape of a parallel lattice pattern so that conduits for the heat transfer medium are formed in the cooling conduits 12. As shown in FIG. 13A, a width D of the spacer 27 may be larger than a width d of the cooling conduits 12. Thus, both edges of the spacer 27 protrude to the sides of the cooling conduits 12. In this case, as shown in FIG. 13B, when sealing members 28 and 29 are each adhered to two sides of the cooling conduits 12 respectively, it is possible to connect the cooling conduits 12 to a supply conduit and an exhaust conduit through the sealing members 28 and 29. Alternatively, the cooling conduits 12 illustrated in FIG. 13A may be inserted into grooves of the supply conduit 13 and the exhaust conduit 14 of FIG. 2A. Alternatively, the sealing members 28 and 29 may be used as the first and second subsidiary conduits 15a and 16a of FIG. 3.

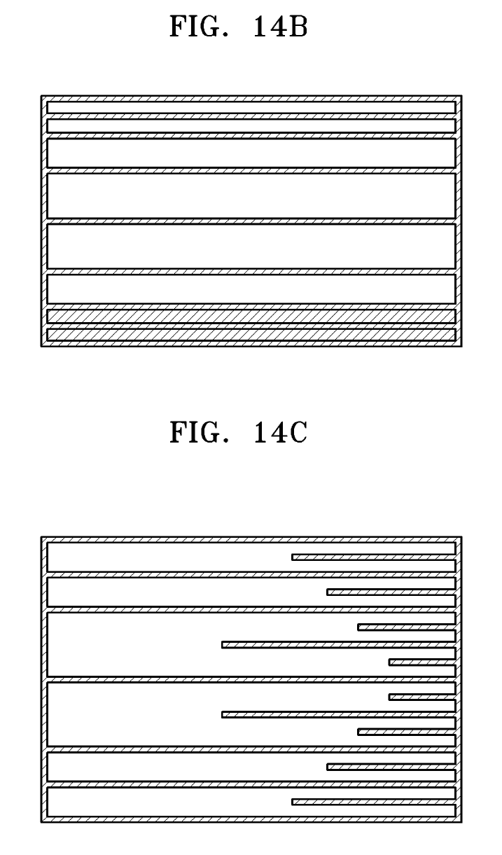

As described above with reference to FIGS. 10A through 10C, the shape of the spacer 27 of FIG. 12 may change according to the location in the cooling conduits 12. FIGS. 14A through 14C are plan views illustrating various modified examples of the spacer 27 of FIG. 12. As shown in FIGS. 14A through 14C, the interval and length of the lattice in the spacer 27 may differ according to the location in the cooling conduits 12.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A secondary battery module comprising:
a plurality of cooling conduits disposed in parallel facing each other and sealed so that a heat transfer medium flows therein;
a plurality of unit batteries disposed between the plurality of cooling conduits;
a supply conduit to supply the heat transfer medium to the plurality of cooling conduits;
an exhaust conduit to exhaust the heat transfer medium from the plurality of cooling conduits; and
a spacer disposed inside each of the plurality of cooling conduits to maintain a space in each of the cooling conduits.

2. The secondary battery module of claim 1, wherein the spacer serves as a compression spring having elasticity in a direction in which the cooling conduits are compressed by the unit batteries on each side of each of the cooling conduits.

3. The secondary battery module of claim 1, wherein the spacers have a shape of a bent board, a shape of a board having an uneven surface or having protrusions, a shape of a board partially cut or having a hole, a mesh shape, a wire shape, a sphere shape, a tube shape, or a combination of shapes thereof.

4. The secondary battery module of claim 1, wherein the spacers are formed separately from the cooling conduits and inserted into the cooling conduits.

5. The secondary battery module of claim 1, wherein the spacers are formed with the cooling conduits as a single body.

6. The secondary battery module of claim 1, wherein a shape, an arrangement configuration, or an arrangement frequency of the spacers differ according to a location of the spacers within the cooling conduits.

7. The secondary battery module of claim 6, wherein an occupation density or occupation surface area of the spacers increases downstream of a moving path of the heat transfer medium in the cooling conduits.

8. The secondary battery module of claim 6, wherein an occupation density of the spacers at the edge of a moving path of the heat transfer medium in the cooling conduits is higher than an occupation density of the spacers at the center of the moving path.

9. The secondary battery module of claim 6, wherein the cooling conduits are divided into a plurality of sections according to location, and spacers disposed in one of the plurality of sections have a shape different from spacers disposed in each of the other sections.

10. The secondary battery module of claim 1, wherein the plurality of cooling conduits and the plurality of unit batteries have flat board shapes having wide and flat surfaces in width and height directions, and narrow and long surfaces in a thickness direction.

11. The secondary battery module of claim 10, wherein the wide and flat surfaces of the cooling conduits and the unit batteries contact each other.

12. The secondary battery module of claim 11, wherein insulation films are disposed between each of the plurality of cooling conduits and the unit batteries.

13. The secondary battery module of claim 10, wherein a thickness of each of the plurality of cooling conduits ranges from about 0.1 mm to about 20 mm.

14. The secondary battery module of claim 1, wherein:
the supply conduit and the exhaust conduit are disposed on sides of the cooling conduits, and
a plurality of parallel grooves are formed on inner walls of the supply conduit and the exhaust conduit.

15. The secondary battery module of claim 14, wherein the plurality of cooling conduits are inserted into the plurality of grooves formed on the inner walls of the supply conduit and the exhaust conduit so as to connect the plurality of cooling conduits to the supply conduit and the exhaust conduit.

16. The secondary battery module of claim 15, wherein the cooling conduits are connected to the supply conduit and the exhaust conduit via a brazing method.

17. The secondary battery module of claim 1, wherein:
the supply conduit and the exhaust conduit have a pipe shape, the supply conduit is disposed on one edge of the cooling conduits, and the exhaust conduit is disposed on another edge of the cooling conduits, and
a plurality of first subsidiary conduits connected to the supply conduit are connected to one corner of the cooling conduits, and a plurality of second subsidiary conduits connected to the exhaust conduit are connected to another corner of the cooling conduits, so as to supply and exhaust the heat transfer medium.

18. The secondary battery module of claim 1, further comprising a separate heat exchanger connected to the supply conduit and the exhaust conduit.

19. The secondary battery module of claim 1, wherein the spacers have a parallel lattice pattern.

20. The secondary battery module of claim 19, wherein a width of the spacers is larger than a width of the cooling conduits.

21. The secondary battery module of claim 1, further comprising:
two end plates respectively disposed on each end of the secondary battery module; and
a restraining unit fixed between the two end plates to provide resistance in a direction such that a distance between the two end plates increases.
